(19) United States
(12) Patent Application Publication
(10) Pub. No.: US 2007/0019818 A1
(43) Pub. Date: Jan. 25, 2007

(54) Device and method for configuring a hearing aid

(76) Inventor: Hans-Rainer Kurz, Wiesmoor (DE)

Correspondence Address: WILLIAM COLLARD;COLLARD & ROE, P.C., 1077 NORTHERN BOULEVARD, ROSLYN, NY, 11576, US

(21) Appl. No.: 11/491,369

(22) Filed: Jul. 21, 2006

(30) Foreign Application Priority Data
Jul. 23, 2005 (DE) 10 2005 034 560.3
Dec. 21, 2005 (DE) 10 2005 061 150.8

(51) Int. Cl. H04R 29/00

(52) U.S. Cl. 381/60

(57) ABSTRACT

A device and method for configuring a hearing aid for a patient has an audiometer that generates test tones and at least one open loudspeaker, brought close to at least one ear of the patient, connected to the audiometer, for transmitting short-pulse test tones generated in the audiometer. Fixed signal intensities, different from one another, are set at the audiometer, and a configuration of the hearing aid is carried out as a function of the patient's individual hearing capacity.

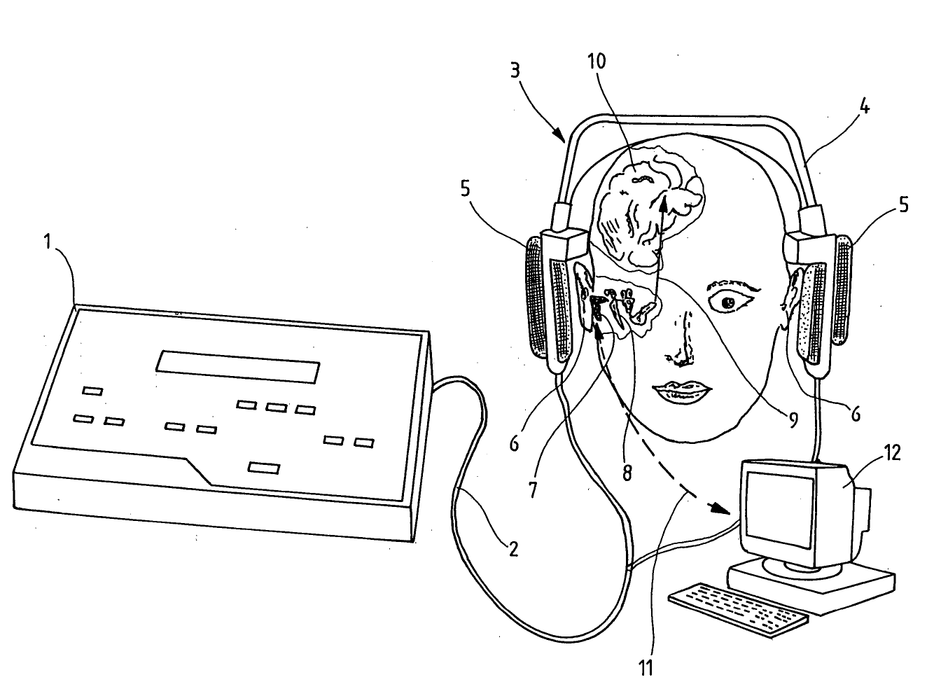

### BACKGROUND OF THE INVENTION

1. Field of the Invention

The invention relates to a device for configuring a hearing aid for a patient, comprising an audiometer that generates test tones, or a measuring device that generates test tones. The invention furthermore relates to a method for configuring a hearing aid for a person, which uses an audiometer that generates test tones and a loudspeaker connected to the audiometer, brought close to at least one ear of the patient, for transmitting test tones generated by the audiometer.

2. The Prior Art

People with hearing problems are frequently equipped with hearing aids in order to eliminate or alleviate the hearing problems. In this connection, it is necessary to fit the hearing aids to the concrete requirements of each patient. The patients have different hearing impairments, and these can also be in different stages. The hearing aids must be fitted to these different impairments and different stages.

In order to be able to fit a hearing aid to a patient, it is necessary to precisely determine his/her hearing ability. Devices as stated initially are used for this determination. These devices comprise audiometers or objective measurement devices with which test tones can be generated, which tones are passed to the patient.

In the state of the art, a standard headset is used for passing the test tones to the patient. This headset surrounds the ear, with a standardized closed residual volume of 20 cm³ remaining. The known audiometers are calibrated to this standard dimension of the headset. However, it is a problem that a residual volume of 20 cm³ does not exist in the case of every patient. The ear anatomies of the patients are different. Because of these differences, there is therefore an error that exists in the case of the devices according to the state of the art.

Errors occur even if the test tones of the audiometer are given off by way of a loudspeaker that stands on the table. This is because aside from the tone from the loudspeaker, the patient is also confronted with other noise sources from his/her surroundings. In addition, the test signal decreases with the square of the distance on its path between the loudspeaker and the patient.

When the test tones that exit from the closed headset or from the loudspeaker standing on the table impact the patient's eardrum, the individual rigidity of the latter must also be taken into consideration. This results in another error.

In the end result, the configuration of the hearing aid performed with the known devices is imprecise. The configuration presents itself as a control circuit composed of the parameters of a closed headset, hearing aid, residual volume of the auditory canal, rigidity-of the eardrum, ear entrance resonances, otoplastic (earpiece), as well as peripheral and central processing. This control circuit is not reproducible. The weakest link in this control circuit chain determines the quality of the acoustical signal. The configuration of the hearing aid is based solely on the subjectively perceived information from the patient. The perception of the patient is clouded by the errors mentioned, the patient frequently becomes tired of the fitting procedure and no longer gives any objective information. He/she only reports hearing impressions that are known to him/her, and not impressions that are necessary for learning to hear, since natural hearing is evaluated as normal, due to alienation.

In the state of the art, both the use of hearing aids and the use of implants has been proposed. These implants can be inserted into the ear region if the ability to hear has been absolutely lost. The implants replace the hearing cells, the wearer of such an implant is able to hear again, and is also able to develop an understanding of speech. It is possible to reach or easily overcome the patient's hearing threshold.

### SUMMARY OF THE INVENTION

It is therefore an object of the invention to provide a device and a method for configuring a hearing aid, by achieving or easily overcoming the patient's hearing threshold. Test signals close to the threshold are guaranteed as perceptions, just as much as signals of comfortable hearing and of the discomfort threshold are.

This object is accomplished according to the invention, by providing an open loudspeaker that can be brought close to at least one ear of the patient, and connecting the loudspeaker to the audiometer, for transmitting test tones generated in the audiometer.

No closed headset with a standardized residual volume is used. Therefore, this error has already been excluded. However, no open loudspeaker positioned at a distance from the ear, past which many interference noises can pass, is used, either. With the device according to the invention, an open, calibrated loudspeaker is used, in order to exclude the standardization errors of the closed headset. However, this loudspeaker is brought close to the patient's ear, in order to guarantee direct introduction of the test tones into the ear.

The test tones used are freely selectable and correspond to the sound volume of a normal hearing person. The test tones can have all possible parameters. They pass by the hearing aid, going past the otoplastic, into the patient's auditory canal, and are introduced into the brain by way of the patient's peripheral and central ear organs. The goal is to first determine the patient's hearing threshold, using the test tones. For this purpose, a signal having the intensity of the patient's hearing threshold if he/she were healthy, for example, is offered with the audiometer or with another measurement device, in fixed manner. Since the patient has a hearing impairment, he/she does not hear anything at first. Now the signal is continuously amplified, in frequency-specific manner, using the hearing aid, until the patient's hearing threshold has been reached neuronally. He/she can then provide objective information as to when this occurs. On the basis of this objective knowledge, it is possible for the hearing aid acoustics technician to configure the hearing aid in such a manner that the patient's hearing threshold is reached at normal use of the hearing aid. The patient is able to process sound waves in his/her neuronal ranges, so that a neuronal network can newly form. The patient can learn to hear again.

With the device according to the invention, the configuration of the hearing aid that is performed is therefore as objective as possible. The parameters of the device as well as the error sources of the devices according to the state of the art that occur during configuration are avoided. In principle, the path of implants is taken, in such a manner that the patient's hearing threshold is objectively reached.

The open loudspeaker is preferably made available by means of an open, calibrated headset. The use of a headset guarantees that the loudspeaker is directly assigned to the patient's ear. The headset is open, so that it does not close off the patient's auditory canals. Preferably, the headset has two loudspeakers, so that both of the patient's ears can be treated, without having to change the position of the headset.

The test tones of the audiometer can be chirp signals, Speechmap signals, or narrow-band signals. The headset can additionally have at least one bone conduction receiver earpiece. This earpiece can be used to make one ear, particularly one that hears better, less able to hear. The audiometer used can also use long-wave, i.e. long-pulse signals, such as sine signals, for example. However, according to the invention, generally short-pulse signals are used to find the patient's hearing threshold. An influence on these signals can be exerted with the patient's hearing aid. The hearing aid then functions as an audiometer. For this purpose, the hearing aid preferably has a specially calibrated desktop, by way of which it can be controlled or programmed. In this connection, preferably all of the control functions that the audiometer has with regard to the control signal can be provided in the case of the desktop-controlled hearing aid, as well. The desktop is freely programmable, its functions can be linked with the functions of the audiometer. Thus, if necessary, audiometer functions can also be carried out via the desktop that programs the hearing aid. In this connection, the desktop of the hearing aid can be inserted into the hearing aid, but it can also be disposed in an external control device that is connected with the hearing aid. This control device is a personal computer, for example. Signals for a bone conduction receiver earpiece, which is used for measurement purposes and/or hearing reduction purposes, can also be generated with the desktop of the hearing aid. These hearing reduction signals are obtained as inferences on the basis of the useful signals. In this connection, hearing reduction signals are transmitted by way of bone acoustics or air acoustics, or at the same time with temporary, level-dependent frequency offset or corresponding automatic functions.

According to another embodiment of the invention, an in situ sensor that can be disposed in the patient's auditory canal is connected with a measurement device, in order to check the working method of the desktop-controlled hearing aid, and in this manner, it is checked whether or not the desktop of the hearing aid, which is being used as an audiometer, actually reaches the desired threshold values. The result of the check can be displayed optically or acoustically. In this connection, the in situ sensor is disposed at the entrance to a patient's auditory canal. Aside from the check previously mentioned, this sensor can also check whether the sound pressure level of the headset is correct, by means of switching it into a measurement device. Using the measurement device, substitution and/or comparison methods can be used for this purpose. Instead of an in situ sensor, a computer tomograph can also be used for this purpose, the results of which can be used for monitoring and serve for programming by way of the calibrated desktop.

In the method according to the invention, the patient is equipped with a hearing aid, and fixed signal intensities, which are different from one another, are set at the audiometer. A configuration of the hearing aid is carried out as a function of the patient's individual hearing capacity.

The state of the art normally uses an audiometer, at which variable signal intensities are set. This variable setting of loud and quiet signals at the audiometer does not take place in the method according to the invention. Instead, fixed signal intensities are set at the audiometer, and short-pulse signals having a fixed signal intensity, i.e. volume, are used for example. These signals pass through the hearing aid without being changed by the hearing aid, at first, if at all possible, in order to reach the patient's hearing threshold. In this connection, a signal intensity is set in a fixed manner for the individual patient, with which his/her hearing threshold can be reached. This signal intensity can be 0 dB or also 65 dB or 90 dB, for example, up to the setting limit.

Reaching the patient's hearing threshold takes place with the hearing aid, for example on the desktop of the hearing aid. The hearing aid can be connected with a control device, such as a personal computer, in order to perform the optimal configuration of the hearing aid. The audiometer now serves merely as a signal source, and the audiometer function is taken over by the desktop of the hearing aid. The audiometer, which serves as a signal source, preferably has all of the above-threshold tests, for example Langenbeck's noise audiometry, SISSI test, and Fowler test. The audiometer is preferably multi-channel and can offer several channels of different frequencies and levels, even above the threshold, at the same time, with both air conduction and bone conduction. The audiometer is preferably additionally equipped with a receiver earpiece that is inserted into the auditory canal of the ear that lies opposite the ear to be measured, and a receiver earpiece that is activated in order to transmit signals for amplification, for example.

With the method according to the invention, low frequencies are optionally combined in groups, and levels give off a signal in the range of interference noise, in summary, which signal is so intense that interference noises above the low-frequency hearing threshold of the person to be measured, in other words the surrounding interference noise (mainly of a low-frequency type) is covered above the threshold, without provoking any upward masking of the high-frequency components to be measured (similar to the Carhardt test or Langenbeck's noise audiometry). For persons whose inner ear is damaged, it is significantly easier, for example in the case of the SISSI test, to hear increments with 1 dB or more intensity increase, than for persons having normal hearing. Despite the offer of noise interference above the hearing threshold in this range to extinguish ambient noises, measurement of high-frequency, energy-low but information-rich threshold values for speech preparation of consonants is more measurable if these are louder than the hearing reduction noises.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

The single figure of the drawing schematically shows a device according to the invention for configuring a hearing aid.

### DETAILED DESCRIPTION OF THE PREFERRED EMBODIMENT

The device in the figure has an audiometer 1. Audiometer 1 can generate acoustic signals that are different from one another. These signals are given off to a headset 3 by way of a cable connection 2.

Headset 3 is an open headset. Two open loudspeakers 5 are disposed on a frame 4, whereby each loudspeaker 5 is assigned to an ear 6 of the patient.

A hearing aid 7 is inserted into right ear 6 of the patient. Hearing aid 7, which is turned on, is disposed in the auditory canal of right ear 6, and stands in direct contact with internal organs 8 of ear 6. Proceeding from internal organs 8, stimulus conduction to brain 10 of the patient takes place, as indicated with arrow 9.

When short-pulse test tones are applied to headset 3 by means of audiometer 1, these test-tones pass through the auditory canal with hearing aid 7 without being changed by hearing aid 7. Internal organs 8 are excited, and stimulus conduction along the arrow 9 to brain 10 takes place when the hearing threshold is exceeded. The patient can give feedback. Hearing aid 7 is now configured by way of a connection with a setting system 12, indicated with a broken-line arrow 11, in such a manner that when normal acoustical signals impact, excitation of brain 10 occurs, and therefore the hearing perception of the patient is improved.

Accordingly, while only a few embodiments of the present invention have been shown and described, it is obvious that many changes and modifications may be made thereunto without departing from the spirit and scope of the invention.

What is claimed is:

1. A device for configuring a hearing aid for a patient, comprising:
an audiometer or measuring device, that generates test tones; and
at least one open loudspeaker connected to the audiometer or measuring device, for transmitting short-pulse test tones generated in the audiometer or measuring device, the open loudspeaker adapted to be brought close to an ear of the patient.

2. A device according to claim 1, wherein the open loudspeaker is disposed in an open headset.

3. A device according to claim 2, wherein the headset has two open loudspeakers.

4. A device according to claim 1, wherein the audiometer or measuring device generates chirp signals as test tones.

5. A device according to claim 1 wherein the audiometer or measuring device generates Speechmap signals as test tones.

6. A device according to claim 1, wherein the audiometer or measuring device generates narrow-band signals as test tones.

7. A device according to claim 1, further comprising a desktop assigned to and controlling the hearing aid.

8. A device according to claim 7, wherein one of the audiometer or measuring device and the desktop has at least one receiver earpiece adapted to be inserted into an auditory canal of an ear that lies opposite the ear to be measured, said receiver earpiece containing a loudspeaker that is activated.

9. A device according to claim 1, wherein the audiometer or measuring device is configured to be multi-channel.

10. A device according to claim 7, wherein one of the audiometer or measuring device and the desktop offers several channels of different frequencies and levels, even above a hearing threshold, with both air conduction and bone conduction, both on a measurement side and on a hearing reduction side at the same time.

11. A device according to claim 7, wherein the desktop is linked with the audiometer or measuring device.

12. A device according to claim 1, further comprising an in situ sensor that can be disposed in an auditory canal of a patient, said sensor being connected to the audiometer or measuring device.

13. A method for configuring a hearing aid for a patient, comprising:
generating test tones via an audiometer;
transmitting said test tones to an ear of the patient via a loudspeaker connected with the audiometer, the loudspeaker being brought close to at least one ear of the patient;
setting fixed signal intensities, different from one another, at the audiometer; and
configuring the hearing aid as a function of the patient's individual hearing capacity.

14. A method according to claim 13, wherein the audiometer is set to a signal intensity of about 0 dB.

15. A method according to claim 13, wherein the audiometer is set to a signal intensity of about 65 dB.

16. A method according to claim 13, wherein the audiometer is set to a signal intensity of more than about 90 dB.

17. A method according to claim 13, wherein the hearing aid functions as the audiometer and is controlled by a desktop assigned to the hearing aid.

18. A method according to claim 17, wherein the audiometer functions are performed by the desktop assigned to the hearing aid.
